(19) United States
(12) Patent Application Publication
(10) Pub. No.: US 2011/0117403 A1
(43) Pub. Date: May 19, 2011

(54) Battery Cell with a Center Pin Comprised of a Low Melting Point Material

(75) Inventors: Weston Arthur Hermann, Palo Alto, CA (US); Vineet Haresh Mehta, San Francisco, CA (US); Sarah G. Stewart, San Francisco, CA (US); Clay Hajime Kishiyama, San Mateo, CA (US)

(73) Assignee: TESLA MOTORS, INC., Palo Alto, CA (US)

(21) Appl. No.: 12/879,854

(22) Filed: Sep. 10, 2010

Related U.S. Application Data
(60) Provisional application No. 61/281,479, filed on Nov. 17, 2009.

(51) Int. Cl. H01M 6/10

(52) U.S. Cl. 429/94

(57) ABSTRACT

A battery is provided that includes a cell case, an electrode assembly and a center pin within the electrode assembly, where the electrode assembly is wrapped around the center pin, and where the center pin is comprised of a material that is rigid within the normal operating temperature range of the battery and deforms, and/or melts, when the battery temperature exceeds the normal operating temperature range of the battery.

### CROSS-REFERENCE TO RELATED APPLICATION

This application claims the benefit of the filing date of U.S. Provisional Patent Application Ser. No. 61/281,479, filed Nov. 17, 2009, the disclosure of which is incorporated herein by reference for any and all purposes.

### FIELD OF THE INVENTION

The present invention relates generally to battery cells and, more particularly, to a method and apparatus for improving the performance of a cell during thermal runaway.

### BACKGROUND OF THE INVENTION

Batteries can be broadly classified into primary and secondary batteries. Primary batteries, also referred to as disposable batteries, are intended to be used until depleted, after which they are simply replaced with one or more new batteries. Secondary batteries, more commonly referred to as rechargeable batteries, are capable of being repeatedly recharged and reused, therefore offering economic, environmental and ease-of-use benefits compared to a disposable battery.

Although rechargeable batteries offer a number of advantages over disposable batteries, this type of battery is not without its drawbacks. In general, most of the disadvantages associated with rechargeable batteries are due to the battery chemistries employed, as these chemistries tend to be less stable than those used in primary cells. Due to these relatively unstable chemistries, secondary cells often require special handling during fabrication. Additionally, secondary cells such as lithium-ion cells tend to be more prone to thermal runaway than primary cells, thermal runaway occurring when the internal reaction rate increases to the point that more heat is being generated than can be withdrawn, leading to a further increase in both reaction rate and heat generation. Eventually the amount of generated heat is great enough to lead to the combustion of the battery as well as materials in proximity to the battery. Thermal runaway may be initiated by a short circuit within the cell, improper cell use, physical abuse, manufacturing defects, or exposure of the cell to extreme external temperatures.

Thermal runaway is of major concern since a single incident can lead to significant property damage and, in some circumstances, bodily harm or loss of life. When a battery undergoes thermal runaway, it typically emits a large quantity of smoke, jets of flaming liquid electrolyte, and sufficient heat to lead to the combustion and destruction of materials in close proximity to the cell. If the cell undergoing thermal runaway is surrounded by one or more additional cells as is typical in a battery pack, then a single thermal runaway event can quickly lead to the thermal runaway of multiple cells which, in turn, can lead to much more extensive collateral damage. Regardless of whether a single cell or multiple cells are undergoing this phenomenon, if the initial fire is not extinguished immediately, subsequent fires may be caused that dramatically expand the degree of property damage. For example, the thermal runaway of a battery within an unattended laptop will likely result in not only the destruction of the laptop, but also at least partial destruction of its surroundings, e.g., home, office, car, laboratory, etc. If the laptop is on-board an aircraft, for example within the cargo hold or a luggage compartment, the ensuing smoke and fire may lead to an emergency landing or, under more dire conditions, a crash landing. Similarly, the thermal runaway of one or more batteries within the battery pack of a hybrid or electric vehicle may destroy not only the car, but may lead to a car wreck if the car is being driven, or the destruction of its surroundings if the car is parked.

One approach to overcoming this problem is by reducing the risk of thermal runaway. For example, to prevent batteries from being shorted out during storage and/or handling, precautions can be taken to ensure that batteries are properly stored, for example by insulating the battery terminals and using specifically designed battery storage containers. Another approach to overcoming the thermal runaway problem is to develop new cell chemistries and/or modify existing cell chemistries. For example, research is currently underway to develop composite cathodes that are more tolerant of high charging potentials. Research is also underway to develop electrolyte additives that form more stable passivation layers on the electrodes. Although this research may lead to improved cell chemistries and cell designs, currently this research is only expected to reduce, not eliminate, the possibility of thermal runaway.

FIG. 1 is a simplified cross-sectional view of a conventional battery 100, for example a lithium ion battery utilizing the 18650 form-factor. Battery 100 includes a cylindrical case 101, an electrode assembly 103, and a cap assembly 105. Case 101 is typically made of a metal, such as nickel-plated steel, that has been selected such that it will not react with the battery materials, e.g., the electrolyte, electrode assembly, etc. Typically cell casing 101 is fabricated in such a way that the bottom surface 107 is integrated into the case, resulting in a seamless lower cell casing. The open end of cell case 101 is sealed by cap assembly 105, assembly 105 including a battery terminal 109, e.g., the positive terminal, and an insulator 111, insulator 111 preventing terminal 109 from making electrical contact with case 101. As shown, a typical cap assembly may also include an internal positive temperature coefficient (PTC) current limiting device, a current interrupt device (CID), and a venting mechanism, the venting mechanism designed to rupture at high pressures and provide a pathway for cell contents to escape. Additionally, cap assembly 105 may contain other seals and elements depending upon the selected design/configuration.

Electrode assembly 103 is comprised of an anode sheet, a cathode sheet and an interposed separator, wound around a center pin 113 to form a ‘jellyroll’. Typically center pin 113 is hollow, i.e., it includes a void 114 running its entire length, thus providing a path for gases formed during an over-pressure event to escape the cell via the vent contained within electrode cap assembly 105. An anode electrode tab 115 connects the anode electrode of the wound electrode assembly to the negative terminal while a cathode tab 117 connects the cathode electrode of the wound electrode assembly to the positive terminal. In the illustrated embodiment, the negative terminal is case 101 and the positive terminal is terminal 109. In most configurations, battery 100 also includes a pair of insulators 119/121. Case 101 includes a crimped portion 123 that is designed to help hold the internal elements, e.g., seals, electrode assembly, etc., in place.

In a conventional cell, such as the cell shown in FIG. 1, a variety of different abusive operating/charging conditions and/or manufacturing defects may cause the cell to begin generating excess internal heat. If the amount of internally generated heat is greater than that which can be effectively withdrawn, the cell may eventually enter into thermal runaway. During a cell abuse situation, it is common for localized hot spots 125 to form which, in turn, heat and weaken adjacent cell wall areas 127 of casing wall 101. At the same time as area 127 is being heated, potentially approaching its melting point, the adjacent area of electrode assembly 103 is deforming and expanding. Given the rigidity of center pin 113, the electrode assembly within this region is forced to expand in an outward direction towards weakened area 127 of the cell casing. As a result, if the cell abuse situation is not quickly abated, the cell may rupture in region 127. Once ruptured, the elevated internal cell pressure will cause additional hot gas to be directed to this location, further compromising the cell at this and adjoining locations and potentially heating adjacent cells to a sufficient temperature to cause them to enter into thermal runaway. Accordingly, it will be appreciated that the rupturing of the wall of one cell can initiate a cascading thermal runaway reaction that can spread throughout the battery pack.

To combat the effects of thermal runaway, and as previously noted, a conventional cell will typically include a venting element within the cap assembly 105 as shown. The purpose of the venting element is to release, in a somewhat controlled fashion, the gas generated during the thermal runaway event, thereby preventing the internal gas pressure of the cell from exceeding its predetermined operating range. While the venting element of a cell may help to control the cell's internal pressure, it may not prevent the rupturing of the cell which is caused, in part, by the outward expansion of the electrode assembly.

Accordingly, what is needed is a means for minimizing the risk of cell wall ruptures during cell abuse, thereby helping to control the occurrence of, and effects of, thermal runaway. The present invention provides means for minimizing the risk of a side wall rupture.

### SUMMARY OF THE INVENTION

The present invention provides a center pin for a battery cell that is comprised of a material that is rigid within the normal operating temperature range of the battery and deforms, and/or melts, when the battery temperature exceeds the normal operating temperature range of the battery. The center pin may be comprised of a material with a melting temperature in the range of 100° C. to 200° C.; alternately, with a melting temperature in the range of 100° C. to 300° C.; alternately, with a melting temperature in the range of 75° C. to 150° C. The center pin may be comprised of a material with a glass transition temperature in the range of 25° C. to 150° C.; alternately, with a glass transition temperature in the range of 25° C. to 100° C.; alternately, with a glass transition temperature in the range of 25° C. to 75° C.; alternately, with a glass transition temperature in the range of 0° C. to 75° C. The center pin may be comprised of a material with a density of less than 5 g/cm³; alternately, with a density of less than 2.5 g/cm³; alternately, with a density of less than 1 g/cm³. The center pin may be comprised of a material with a negative coefficient of thermal expansion; alternately, with a linear coefficient of thermal expansion of less than 200 ppm/° C.; alternately, with a linear coefficient of thermal expansion of less than 150 ppm/° C.; alternately, with a linear coefficient of thermal expansion of less than 100 ppm/° C.; alternately, with a linear coefficient of thermal expansion of less than 75 ppm/° C. The center pin may be comprised of a polymer, such as polypropylene, polyethylene terephthalate, or polystyrene. The center pin may be comprised of a fiber-reinforced material, such as a phenolic or a glass fiber/plastic composite. The battery may utilize an 18650 form-factor. The center pin may be solid, or may include a void extending longitudinally from the first center pin end surface to the second center pin end surface. The battery may further comprise a first venting structure within a cap assembly mounted to a first end portion of the cell case and proximate to a first end of the center pin, and a second venting structure located on a second end portion of the cell case and proximate to a second end of the center pin.

A further understanding of the nature and advantages of the present invention may be realized by reference to the remaining portions of the specification and the drawings.

### BRIEF DESCRIPTION OF THE DRAWINGS

FIG. 1 is a simplified cross-sectional illustration of a cell utilizing the 18650 form-factor in accordance with the prior art;

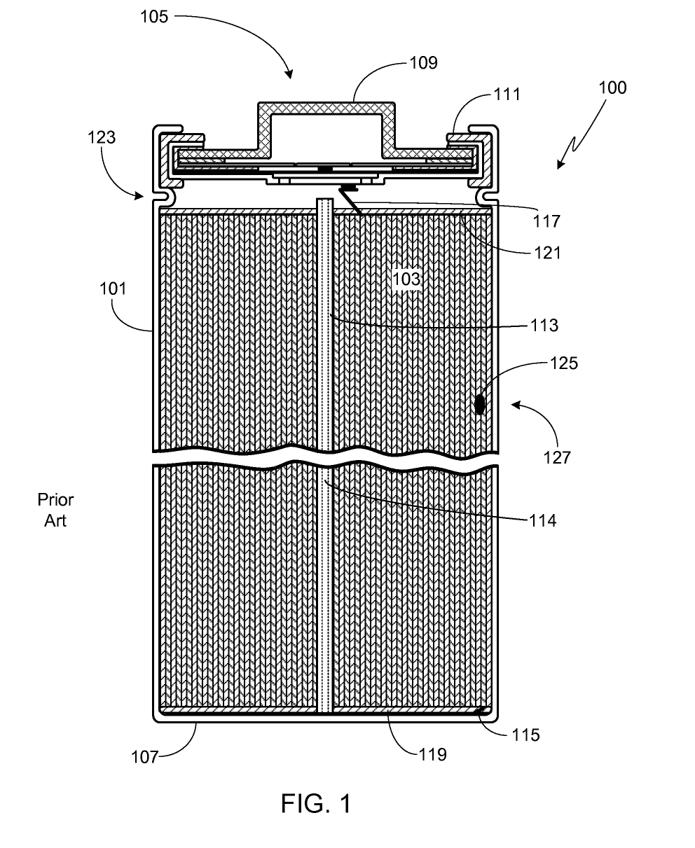

FIG. 2 is a cross-sectional view of an 18650 format cell that includes a center pin in accordance with the invention;

FIG. 3 is a cross-sectional view of an alternate embodiment of the invention in which the center pin is solid;

FIG. 4 is a cross-sectional view of an alternate embodiment based on the cell shown in FIG. 2, with the addition of a lower vent; and

FIG. 5 is a cross-sectional view of an alternate embodiment based on the cell shown in FIG. 3, with the addition of a lower vent.

### DESCRIPTION OF THE SPECIFIC EMBODIMENTS

In the following text, the terms “battery”, “cell”, and “battery cell” may be used interchangeably and may refer to any of a variety of different cell types, chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration. The terms “center pin” and “center mandrel” may be used interchangeably herein and refer to a central element within a cell about which the electrodes are wound. It should be understood that identical element symbols used on multiple figures refer to the same component, or components of equal functionality. Additionally, the accompanying figures are only meant to illustrate, not limit, the scope of the invention and should not be considered to be to scale.

In a conventional cell, the center pin simplifies the fabrication of the electrode assembly and prevents electrode assembly deformation during normal charging and discharging operation. Unfortunately, when the cell is undergoing abusive operating conditions, for example, over-charging, internal shorting, thermal runaway, etc., preventing the electrode assembly from deforming may increase the risk of the cell rupturing, thereby increasing the risk of extensive collateral damage. To avoid this issue while still retaining the benefits of a center pin, the present invention utilizes a center pin that melts, or at least deforms, during cell abuse, but remains rigid during the manufacturing process and during normal charging/discharging operations. Thus during normal operation of the battery, i.e., during normal charging and discharging cycles, the center pin of the invention prevents excessive deformation of the electrode assembly, thereby preventing electrode delamination and/or electrode shorting. During abnormal operation of the battery, i.e., during a cell abuse situation, the center pin of the invention deforms or melts. By allowing center pin deformation in such a situation, the electrode assembly is then allowed to deform in an inward direction, thereby preventing, or at least minimizing, the risk of the electrode assembly deforming in an outward direction and potentially rupturing the cell side wall.

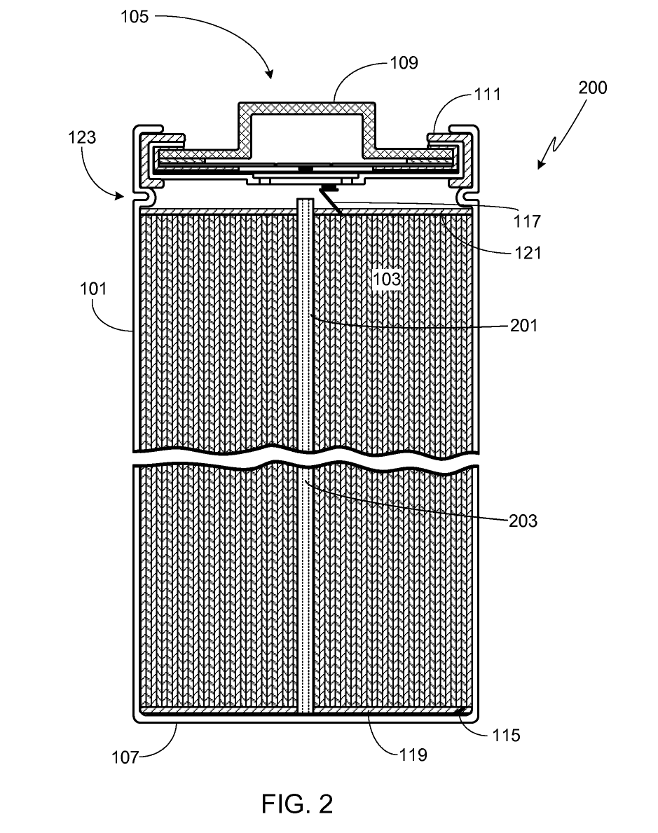

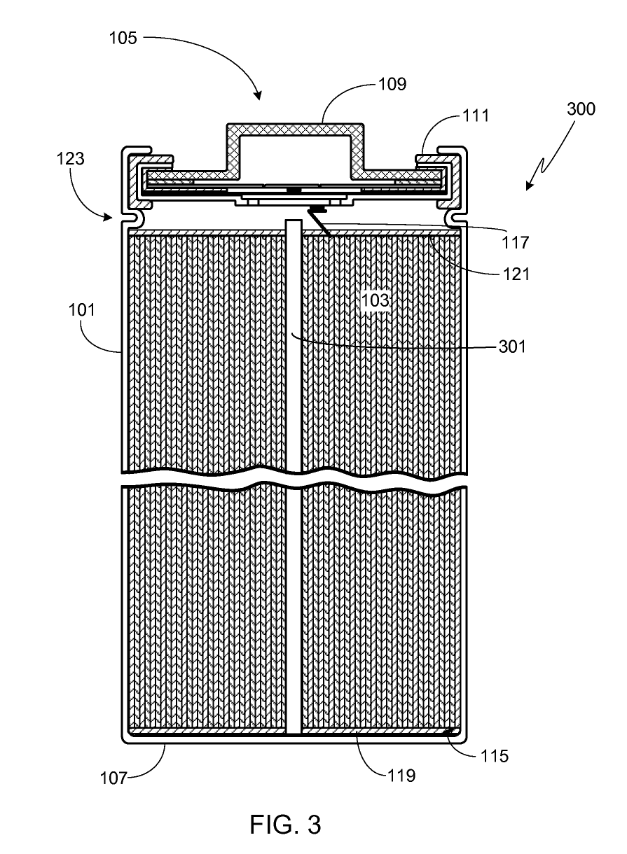

In accordance with the invention, and as illustrated in FIGS. 2 and 3, the center pin of the invention is fabricated from a material that is rigid at room temperature and remains rigid during normal battery use, but softens, or completely melts, as the battery temperature exceeds the desired operating temperature. In cell 200, center pin 201 includes a central void 203 running the length of the pin, thus allowing gas flow to pass through the pin. During a cell abuse situation, if the degree of center pin 201 deformation is sufficient, void 203 may collapse. While the collapse of void 203 prevents the passing of gas through the pin, its collapse provides further volume for the inwardly directed deformation of the electrode assembly. In the alternate embodiment illustrated in FIG. 3, cell 300 utilizes a solid center pin 301.

The center pin of a cell designed in accordance with the invention, i.e., pin 201 of cell 200 or pin 301 of cell 300, is fabricated from a material that easily deforms when the temperature of the cell exceeds the desired operating range of the cell, the cell's operating range being defined to include both charging and discharging cycles. It will be appreciated that the material selected for the center pin, and thus the temperature at which pin deformation occurs, depends upon the desired operating range, and thus the specific cell configuration and chemistry and, to a lesser extent, the intended application. In at least one embodiment, deformation is desired after the cell exceeds a temperature of 75° C.; alternately, after the cell exceeds a temperature of 90° C.; alternately, after the cell exceeds a temperature of 100° C.; alternately, after the cell exceeds a temperature of 125° C. It will be appreciated that the cell may be intended to operate within any of a variety of temperature ranges and therefore the preferred deformation temperatures noted above are only exemplary, not limiting.

In order to achieve the desired deformation when the cell's temperature exceeds its desired operating range, preferably the material selected for the center pin undergoes a first order transition, i.e., undergoing a transformation from a solid to a liquid, at a melting point temperature that is close to, but greater than, the highest expected temperature within the cell's normal operating range. Alternately, the material selected for the center pin may be selected to undergo a second order transition at, or above, the cell's intended operating range. A second order transition is one in which a material such as a polymer changes from a high viscosity material to a low viscosity material. Accordingly, if the material selected for the center pin has a glass transition temperature, preferably the glass transition temperature is close to, but greater than, the highest expected temperature within the cell's normal operating range. Alternately, the selected material may have a glass transition temperature within the cell's normal operating range. Preferably if the material has a glass transition temperature within the cell's normal operating range, its melting point is near, or above, the highest expected temperature within the cell's normal operating range.

In at least one embodiment, the center pin of the invention, e.g., pin 201 or 301, has a melting temperature in the range of 100° C. to 200° C. In at least one alternate embodiment, the center pin has a melting temperature in the range of 100° C. to 300° C. In at least one alternate embodiment, the center pin has a melting temperature in the range of 75° C. to 150° C.

In at least one embodiment, the center pin of the invention, e.g., pin 201 or 301, has a glass transition temperature in the range of 25° C. to 150° C. In at least one alternate embodiment, the center pin has a glass transition temperature in the range of 25° C. to 100° C. In at least one alternate embodiment, the center pin has a glass transition temperature in the range of 25° C. to 75° C. In at least one alternate embodiment, the center pin has a glass transition temperature in the range of 0° C. to 75° C.

In addition to selecting the material for the center pin based on the temperature at which the pin may be deformed, thereby allowing inwardly directed electrode assembly movement during cell abuse, preferably other, secondary material qualities are also considered when selecting the center pin material. The primary secondary material qualities of interest are mass and material density. It will be appreciated that even a minor reduction in cell weight may have a large impact on system weight in applications, such as electric vehicles, which routinely use thousands of cells. Preferably the selected material has a density of less than 5 g/cm³, more preferably less than 2.5 g/cm³, and still more preferably less than 1 g/cm³.

Another material quality that may be considered during the selection of the center pin material is the coefficient of thermal expansion for the material. Typically a material's volume expands upon heating, this expansion primarily occurring when the material's temperature exceeds its glass transition temperature (if the material has a glass transition temperature) and/or its melting point. While the extent of a center pin's volume expansion may be minor, it will be appreciated that any volume expansion of the center pin lowers the available volume for inwardly directed electrode assembly deformation. Accordingly, preferably the selected material undergoes volume contraction (i.e., negative thermal expansion). If a material with positive thermal expansion is selected, preferably the selected material has a linear coefficient of expansion less than 200 ppm/° C., more preferably less than 150 ppm/° C., still more preferably less than 100 ppm/° C., and yet still more preferably less than 75 ppm/° C.

In addition to the primary and secondary material characteristics noted above with respect to the center pin of the invention, it will be appreciated that the material selected for the center pin must be chemically resistant to the materials used within the battery (e.g., the electrode assembly 103 and the electrolyte contained therein).

As noted above, a cell fabricated in accordance with the invention has a center pin that is rigid at room temperature and remains rigid during normal battery use, but softens, or melts, as the battery temperature exceeds the desired operating temperature. Preferred exemplary materials include plastics (e.g., polypropylene, polyethylene terephthalate (PET), polystyrene, etc.) or similar polymers. Alternately, a composite may be used such as a fiber-reinforced material (e.g., garolite phenolic, glass fiber/plastic composite, etc.).

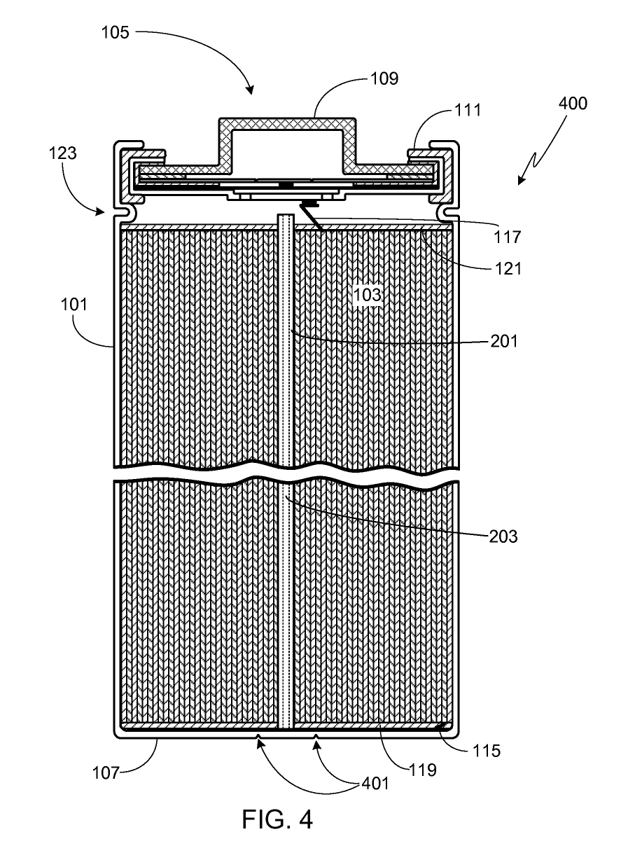

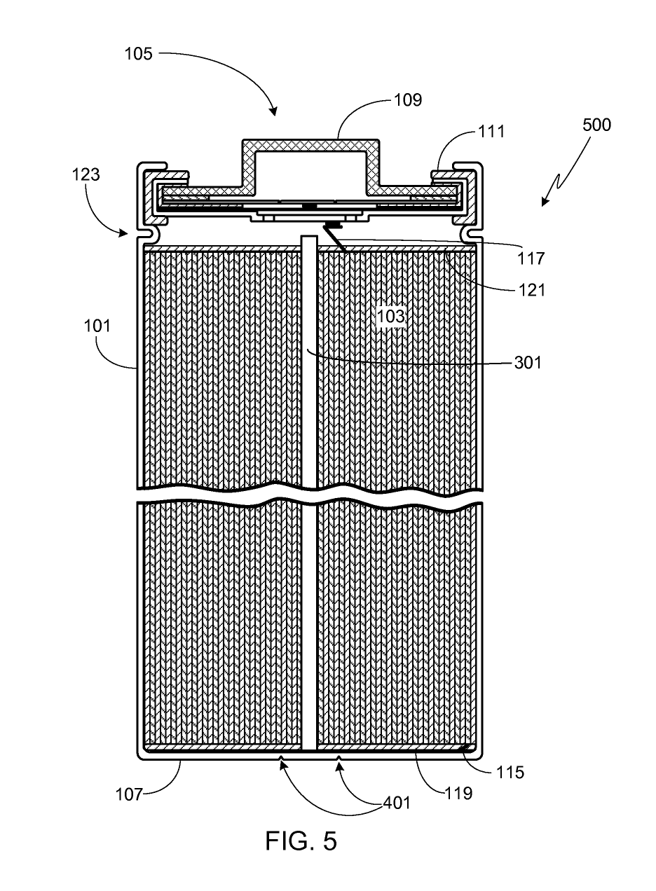

As described above, the center pin of a cell fabricated in accordance with the invention is designed to deform, or completely melt, when the cell temperature exceeds the desired operating range. As a result, even if the pin includes a void as shown in FIG. 2, the void is likely to collapse during the cell abuse event. Accordingly, in at least one preferred embodiment of the invention, the cell includes a venting structure on both ends of the cell. Preferably the cell utilizes a conventional venting structure in the cap assembly 105. Preferably the bottom vent is formed by scoring 401 the bottom cell surface 107 as shown in cells 400 and 500 (FIGS. 4 and 5, respectively). Scoring 401 may utilize a circular or other pattern, the primary consideration being the ability of the scored region to rapidly rupture during cell over-pressure, thus further decreasing the risk of the cell rupturing through a cell side wall during thermal runaway or other abusive situation. Note that in accordance with the invention, the bottom surface vent, for example formed by scoring 401, may be used with either a hollow center pin (e.g., FIG. 4) or a solid center pin (e.g., FIG. 5).

Throughout the specification, the invention is primarily described relative to cells using the 18650 form-factor. It should be understood, however, that the invention may also be applied to other cell designs, shapes, chemistries, and form-factors in which the cell utilizes a center pin. For example, the invention may be used with a prismatic cell, in which case the center pin, also referred to as a mandrel, utilizes a square or rectangular shape.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A battery, comprising:
a cell case;
an electrode assembly contained within said cell case; and
a center pin within said electrode assembly, wherein said electrode assembly is wrapped around said center pin, and wherein said center pin is comprised of a material that is rigid within the normal operating temperature range of the battery and deforms when a battery temperature exceeds the normal operating temperature range of the battery.

2. The battery of claim 1, wherein said material comprising said center pin melts when the battery temperature exceeds the normal operating temperature range.

3. The battery of claim 1, wherein said material comprising said center pin has a melting temperature in the range of 100° C. to 200° C.

4. The battery of claim 1, wherein said material comprising said center pin has a melting temperature in the range of 100° C. to 300° C.

5. The battery of claim 1, wherein said material comprising said center pin has a melting temperature in the range of 75° C. to 150° C.

6. The battery of claim 1, wherein said material comprising said center pin has a glass transition temperature in the range of 25° C. to 150° C.

7. The battery of claim 1, wherein said material comprising said center pin has a glass transition temperature in the range of 25° C. to 100° C.

8. The battery of claim 1, wherein said material comprising said center pin has a glass transition temperature in the range of 25° C. to75° C.

9. The battery of claim 1, wherein said material comprising said center pin has a glass transition temperature in the range of 0° C. to75° C.

10. The battery of claim 1, wherein said material comprising said center pin has a density of less than 5 g/cm³.

11. The battery of claim 1, wherein said material comprising said center pin has a density of less than 2.5 g/cm³.

12. The battery of claim 1, wherein said material comprising said center pin has a density of less than 1 g/cm³.

13. The battery of claim 1, wherein said material comprising said center pin has a negative coefficient of thermal expansion.

14. The battery of claim 1, wherein said material comprising said center pin has a linear coefficient of thermal expansion of less than 200 ppm/° C.

15. The battery of claim 1, wherein said material comprising said center pin has a linear coefficient of thermal expansion of less than 150 ppm/° C.

16. The battery of claim 1, wherein said material comprising said center pin has a linear coefficient of thermal expansion of less than 100 ppm/° C.

17. The battery of claim 1, wherein said material comprising said center pin has a linear coefficient of thermal expansion of less than 75 ppm/° C.

18. The battery of claim 1, wherein said material comprising said center pin is comprised of a polymer.

19. The battery of claim 1, wherein said material comprising said center pin is selected from the group consisting of polypropylenes, polyethylene terephthalates, and polystyrenes.

20. The battery of claim 1, wherein said material comprising said center pin is comprised of a fiber-reinforced material.

21. The battery of claim 1, wherein said material comprising said center pin is selected from the group consisting of phenolics and glass fiber/plastic composites.

22. The battery of claim 1, wherein said battery has an 18650 form-factor.

23. The battery of claim 1, wherein said battery is a prismatic cell and said center pin is rectangularly-shaped.

24. The battery of claim 1, further comprising:
a cap assembly mounted to a first end portion of said cell case and proximate to a first end of said center pin, said cap assembly including a first venting structure and a battery terminal electrically isolated from said cell case and electrically connected to a first electrode of said electrode assembly, wherein a second electrode of said electrode assembly is electrically connected to said cell case; and
a second venting structure located on a second end portion of said cell case and proximate to a second end of said center pin.

25. The battery of claim 1, wherein said center pin is solid.

26. The battery of claim 1, wherein said center pin includes a void, said void extending longitudinally from a first end surface of said center pin to a second end surface of said center pin.
